(19) United States
(12) Patent Application Publication
(10) Pub. No.: US 2023/0318077 A1
(43) Pub. Date: Oct. 5, 2023

(54) BATTERY MODULE

(71) Applicant: HONDA MOTOR CO., LTD., Tokyo (JP)

(72) Inventors: Hidemasa Usui, Wako-Shi (JP); Takahiro Tamura, Wako-Shi (JP); Takahiro Yasue, Wako-Shi (JP)

(73) Assignee: HONDA MOTOR CO., LTD., Tokyo (JP)

(21) Appl. No.: 18/113,813

(22) Filed: Feb. 24, 2023

(30) Foreign Application Priority Data
Mar. 31, 2022 (JP) 2022-060710

(51) Int. Cl. H01M 10/655; H01M 10/613; H01M 10/6567; H01M 10/615; H01M 50/204; H01M 10/0525

(52) U.S. Cl. CPC H01M 10/655; H01M 10/0525; H01M 10/613; H01M 10/615; H01M 10/6567; H01M 50/204

(57) ABSTRACT

There is provided with a battery module capable of improving cooling and heating efficiency of a battery. The battery module comprises: a plurality of secondary batteries; a cooling and heating unit configured to cool or heat the secondary batteries; and a heat transfer member disposed between the secondary batteries and the cooling and heating unit, a highly viscous fluid in contact with the secondary batteries and an intermediate member in contact with and holding the highly viscous fluid are arranged between the secondary batteries and the heat transfer member.

### CROSS-REFERENCE TO RELATED APPLICATION(S)

This application claims priority to and the benefit of Japanese Patent Application No. 2022-060710 filed on Mar. 31, 2022, the entire disclosure of which is incorporated herein by reference.

### BACKGROUND OF THE INVENTION

### Field of the Invention

The present invention relates to a battery module.

### Description of the Related Art

In order to reduce CO₂ from the viewpoint of climate-related disasters, electrification of industrial machines has been promoted, and research on secondary batteries has also been conducted for applications such as vehicles as energy sources thereof. In a secondary battery group (battery module) including such a secondary battery (battery), since the performance, life, or the like of the battery may be affected by temperature, a structure for adjusting the temperature of the battery may be provided. Japanese Patent Laid-Open No. 2015-225765 describes a battery module including a thermally conductive material in contact with a battery and a cooling plate.

In cooling and heating of the battery, it may be required to efficiently transfer heat of the battery or heat to the battery. However, depending on a degree of contact between the battery and the thermally conductive material, cooling and heating efficiency may decrease, and there is room for improvement in a cooling and heating structure.

### SUMMARY OF THE INVENTION

One embodiment of the present invention provides a battery module capable of improving cooling and heating efficiency of a battery. Furthermore, one embodiment of the present invention contributes to energy efficiency.

According to one embodiment of the present invention, a battery module comprises: a plurality of secondary batteries; a cooling and heating unit configured to cool or heat the secondary batteries; and a heat transfer member disposed between the secondary batteries and the cooling and heating unit, wherein a highly viscous fluid in contact with the secondary batteries and an intermediate member in contact with and holding the highly viscous fluid are arranged between the secondary batteries and the heat transfer member.

### BRIEF DESCRIPTION OF THE DRAWINGS

FIG. 1 is a cross-sectional view schematically illustrating a battery module BM according to one embodiment;

FIG. 2 is a front view of a secondary battery according to one embodiment;

FIG. 3 is a cross-sectional view of the secondary battery according to one embodiment taken along line A-A;

FIG. 4 is a plan view illustrating a configuration of a material for forming an exterior body according to one embodiment;

FIG. 5 is a view taken in the direction of arrow C in FIG. 4;

FIG. 6 is a schematic view of a cooling and heating structure provided in the secondary battery according to one embodiment; and

FIG. 7 is a cross-sectional view taken along line B-B of the cooling and heating structure provided in the secondary battery according to one embodiment.

### DESCRIPTION OF THE EMBODIMENTS

Hereinafter, embodiments will be described in detail with reference to the attached drawings. Note that the following embodiments are not intended to limit the scope of the claimed invention, and limitation is not made an invention that requires all combinations of features described in the embodiments. Two or more of the multiple features described in the embodiments may be combined as appropriate. Furthermore, the same reference numerals are given to the same or similar configurations, and redundant description thereof is omitted.

A battery module according to the present embodiment includes a plurality of secondary batteries, a cooling and heating unit configured to cool or heat the secondary batteries, and a heat transfer member disposed between the secondary battery and the cooling and heating unit. In addition, a highly viscous fluid in contact with the secondary battery and an intermediate member in contact with and holding the highly viscous fluid are arranged between the secondary battery and the heat transfer member. As a result, cooling and heating efficiency of a battery can be improved.

### Battery Module BM

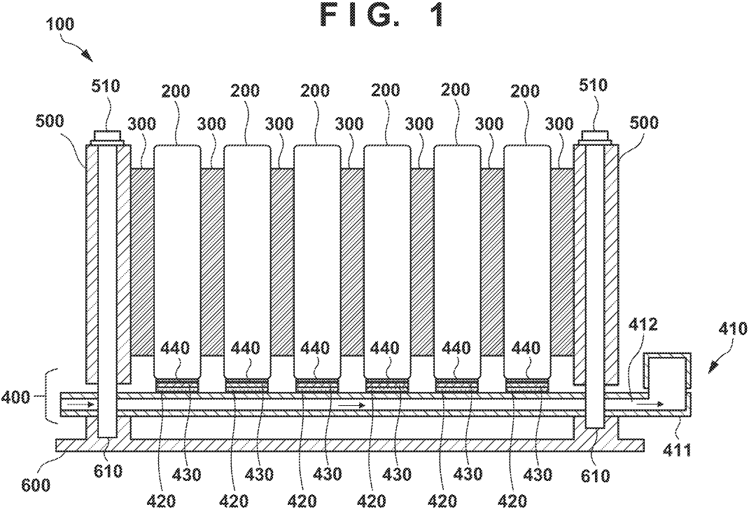

FIG. 1 is a cross-sectional view schematically illustrating a battery module BM according to one embodiment. A battery module 100 can be mounted on, for example, an electric vehicle such as a hybrid car or an EV (not illustrated). The battery module 100 includes a plurality of secondary batteries 200, a plurality of separators 300, and a cooling and heating structure 400.

The plurality of secondary batteries 200 (batteries) are stacked in the thickness direction (Z direction) to constitute a battery group. The secondary batteries 200 are alternately stacked in the Z direction with the separators 300 having insulating properties while being arranged in a standing posture. End plates 500 having a substantially flat plate shape are arranged at both ends in a stacking direction of a stacked product of the secondary battery 200 and the separator 300. A hole through which a fastening bolt 510 for fixing the battery module 100 to an installation site 600 can penetrate is formed in the end plate 500. The installation site 600 is formed with, for example, a pair of female screw portions 610 which is formed of a sheet metal of an electric vehicle and into which a pair of the fastening bolts 510 is screwed.

### Secondary Battery

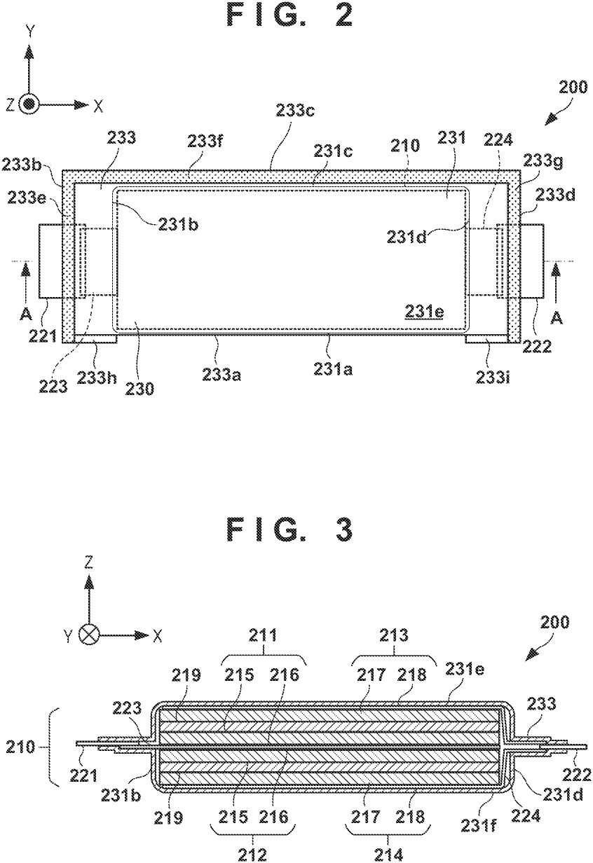

FIG. 2 is a front view of the secondary battery according to one embodiment, and FIG. 3 is a cross-sectional view of the secondary battery according to one embodiment taken along line A-A. In the drawing, an arrow X indicates a longitudinal direction of the secondary battery 200 (or an extending direction of a lead terminal), an arrow Y indicates a width direction of the secondary battery 200 (or a direction orthogonal to the extending direction of the lead terminal), and an arrow Z indicates the thickness direction of the secondary battery 200 (stacking direction of a laminate 210). The X direction, the Y direction, and the Z direction are orthogonal to each other. FIG. 2 is a view of the secondary battery 200 as viewed in the Z direction, and is a view as viewed from the stacking direction of the stacked product of the secondary battery 200 and the separator 300 illustrated in FIG. 1.

The secondary battery 200 includes the laminate 210 that is an element of the secondary battery, lead terminals 221 and 222, current collecting terminals 223 and 224, and an exterior body 230 wrapping the laminate 210, and has a form of a battery cell suitable for an assembled battery.

The laminate 210 has a rectangular parallelepiped shape as a whole, and as illustrated in FIG. 3, includes two positive electrode layers 211 and 212 and two negative electrode layers 213 and 214, and has a structure including the two positive electrode layers and the two negative electrode layers. However, as the laminate 210, the positive electrode layer and the negative electrode layer may be one layer or three or more layers. Solid electrolyte layers 219 are respectively provided between the positive electrode layer 211 and the negative electrode layer 213 and between the positive electrode layer 212 and the negative electrode layer 214.

The positive electrode layers 211 and 212 each include a positive electrode active material layer 215, and have a positive electrode current collector 216 common to the two positive electrode layers 211 and 212. The positive electrode current collector 216 is disposed in a layered manner at the center of the laminate 210 in the Z direction, and the positive electrode active material layers 215 are stacked on the front and back sides thereof.

The negative electrode layers 213 and 214 are arranged outside in one direction and outside in the other direction in the Z direction with respect to the positive electrode layers 211 and 212, and these layers are stacked such that the negative electrode layers 213 and 214 sandwich the positive electrode layers 211 and 212. However, contrary to the configuration of the present embodiment, it is also possible to adopt a configuration in which those layers are stacked such that the two positive electrode layers sandwich the two negative electrode layers. The negative electrode layers 213 and 214 each include a negative electrode active material layer 217 and a negative electrode current collector 218. The two negative electrode current collectors 218 are each formed in a layered manner on an outermost layer of the laminate 210.

Examples of the active material constituting the positive electrode active material layer 215 include lithium cobalt oxide, lithium nickel oxide, lithium manganese oxide, and lithium metal phosphate. Examples of the active material constituting the negative electrode active material layer 217 include a lithium-based material and a silicon-based material. Examples of the lithium-based material include Li metal and Li alloy. Examples of the silicon-based material include Si and SiO. Other examples of the active material constituting the negative electrode active material layer 217 include carbon materials such as graphite, soft carbon, and hard carbon, tin-based materials (Sn, SnO, and the like), and lithium titanate.

The electrolyte layer 219 includes, for example, a solid, gel, or liquid electrolyte having ion conductivity, and examples of the material include a sulfide-based solid electrolyte material, an oxide-based solid electrolyte material, a nitride-based solid electrolyte material, a halide-based solid electrolyte material, a lithium-containing salt, and a gel material containing a lithium ion conductive ionic liquid. The positive electrode current collector 216 and the negative electrode current collector 218 are formed of, for example, a metal foil, a metal sheet, or a metal plate, such as aluminum, copper, or SUS. The positive electrode active material layer 215, the negative electrode active material layer 217, and the electrolyte layer 219 may be formed by bonding particles of substances constituting these layers with an organic polymer compound-based binder. In one embodiment, the secondary battery 200 may be an all-solid-state battery.

The lead terminals 221 and 222 are connected to a charger or an electric load to charge or discharge the laminate 210. One end portions of the lead terminals 221 and 222 are located outside the exterior body 230, and the other end portions are located inside the exterior body 230. In this case, the inside of the exterior body 230 refers to a space formed by a sealing portion of the exterior body 230 described later.

The other end portion of the lead terminal 221 is connected to the positive electrode current collector 216 via the current collecting terminal 223 inside the exterior body 230, and the lead terminal 221 forms a positive electrode terminal. The lead terminal 221 and the current collecting terminal 223 are formed of, for example, a conductive metal sheet or metal plate. On the other hand, the other end portion of the lead terminal 222 is connected to the negative electrode current collector 218 via the current collecting terminal 224 inside the exterior body 230, and the lead terminal 222 forms a negative electrode terminal. The lead terminal 222 and the current collecting terminal 224 are formed of, for example, a conductive metal sheet or metal plate.

The arrangement of the lead terminals 221 and 222 is not particularly limited, and the lead terminals 221 and 222 may be arranged at both ends in the longitudinal direction (X direction) of the secondary battery 200, or may be arranged at one end (arranged above) in the width direction (Y direction) of the secondary battery 200. In one embodiment, the lead terminals 221 and 222 are arranged at both ends in the longitudinal direction (X direction) of the secondary battery 200, and in this arrangement, a current flows in the longitudinal direction of the secondary battery 200 during charging and generates heat accordingly. However, since the cooling and heating structure 400 is disposed along the longitudinal direction of the secondary battery 200, cooling efficiency of the secondary battery 200 is improved.

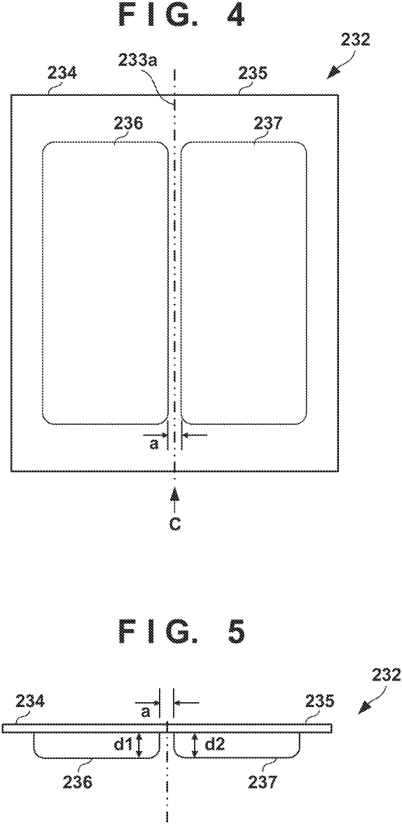

FIG. 4 is a plan view illustrating a configuration of a material for forming the exterior body according to one embodiment, and FIG. 5 is a view taken in the direction of arrow C in FIG. 4. The exterior body 230 wraps the laminate 210. In the present embodiment, the exterior body 230 is formed by folding a material forming the exterior body 230, for example, a laminate film 232 in two. The laminate film 232 is formed by, for example, covering front and back surfaces of a metal layer with a resin layer (insulating layer). The exterior body 230 formed of the laminate film 232 has flexibility capable of following expansion and contraction of the laminate 210. The flexibility capable of following the expansion and contraction of the laminate 210 can be obtained by the way of wrapping the laminate 210, the shape and structure of the exterior body 230, and the like.

In the present embodiment, the exterior body 230 includes a housing portion 231 which is located at a central portion thereof when viewed in the Z direction and houses the laminate 210, and a peripheral edge portion 233 around the housing portion 231. The peripheral edge portion 233 has four sides 233a to 233d when viewed in the Z direction.

The housing portion 231 is formed by overlapping recesses 236 and 237, respectively formed in portions 234 and 235 on both sides of a bent portion a in a state where the laminate film 232 is opened, when the laminate film 232 is folded. The housing portion 231 includes principal surfaces 231e and 231f that extend in a plane (XY plane) intersecting the stacking direction (Z direction) of the laminate 210 and face each other, and side surfaces 231a to 231d arranged so as to connect the principal surfaces 231e and 231f.

The peripheral edge portion 233 is formed by overlapping portions where the recesses 236 and 237 are not formed in the state where the laminate film 232 is opened. In the present embodiment, the side 233a of the four outer sides of the peripheral edge portion 233 is included in the bent portion a formed when the laminate film 232 is bent, and one site (side surface 231a) of the housing portion 231 includes a part of the bent portion a therealong.

In FIGS. 4 and 5, in order to facilitate understanding of the bent portion a, although the bent portion a is shown to be wide, the side surface 231a of the housing portion 231 including the bent portion a has a flat portion as illustrated in FIGS. 1 and 2. In other words, among the side surfaces of the housing portion 231, the peripheral edge portion 233 extends from the side surfaces 231b to 231d in a substantially normal direction of the surface, whereas with respect to the side surface 231a, the side 233a of the peripheral edge portion 233 does not substantially extend.

As illustrated in FIG. 2, the other three sides 233b to 233d of the peripheral edge portion 233 include sealing portions 233e to 233 g. The sealing portions 233e to 233 g are formed by bonding a material (laminate film 232) of the exterior body 230 by adhesion, welding or the like. On the sides 233b and 233d facing each other among the three sides 233b to 233d, the lead terminals 221 and 222 are provided so as to cross the sealing portions 233e and 233 g, respectively.

### Cooling and Heating Structure

As illustrated in FIG. 1, when the secondary battery 200 is used for the battery module 100, the secondary battery 200 is disposed such that a predetermined surface of the secondary battery 200 faces the heat transfer member 420. At this time, in order to efficiently transfer heat of the secondary battery 200 or heat to the secondary battery 200, the secondary battery 200 (exterior body 230) and the heat transfer member 420 are preferably connected by a member. Therefore, in the present embodiment, the cooling and heating structure 400 of the secondary battery 200 described below is adopted.

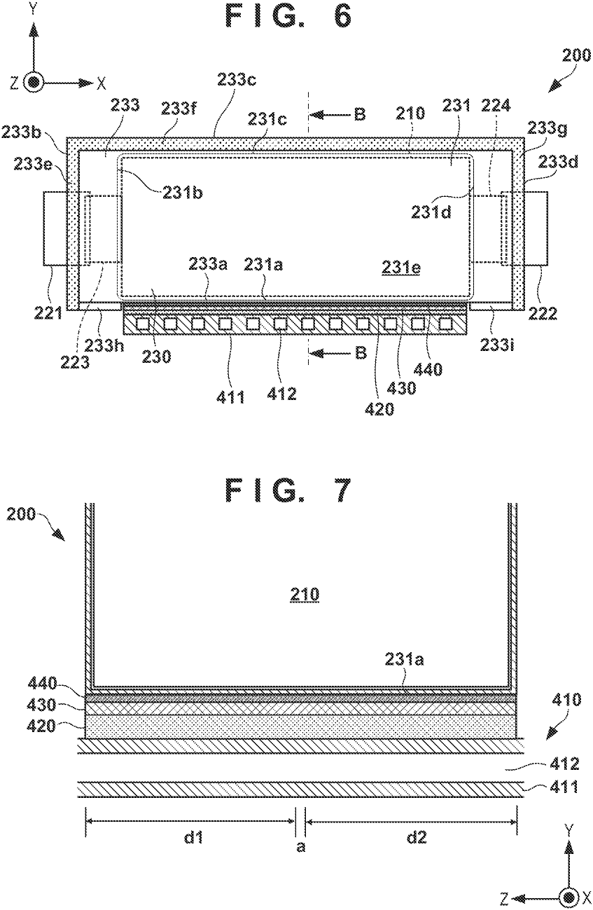

As illustrated in FIG. 1, in one embodiment, the cooling and heating structure 400 includes a cooling and heating unit 410, a plurality of the heat transfer members 420, a plurality of intermediate members 430, and a plurality of highly viscous fluids 440. In another embodiment, the cooling and heating structure 400 may include the cooling and heating unit 410, the heat transfer member 420, the intermediate member 430, and the highly viscous fluid 440 in contact with the plurality of secondary batteries 200. FIG. 6 is a schematic view of the cooling and heating structure provided in the secondary battery according to one embodiment. FIG. 6 is a view of the secondary battery 200 and the cooling and heating structure 400 as viewed in the Z direction, and is a view as viewed from the stacking direction of the stacked product of the secondary battery 200 and the separator 300 illustrated in FIG. 1. FIG. 7 is a cross-sectional view taken along line B-B of the cooling and heating structure provided in the secondary battery according to one embodiment, and is a view illustrating a lower portion of the secondary battery 200 and the cooling and heating structure 400.

As described above, the exterior body 230 is formed by folding the laminate film 232 in two and bonding by adhesion, welding, or the like so as to include the three sides 233b to 233d of the peripheral edge portion 233. The sealing portions 233e to 233 g are formed by this bonding, and accordingly, the laminate film 232 is adhered or pressure-bonded; therefore, the sealing portions 233e and 233 g and, depending on the bonding, portions 233h and 233i (hereinafter, referred to as the “protruding portion 233h” and the “protruding portion 233i”) adjacent thereto protrude from the bent portion a of the housing portion 231 (or the side surface 231a of the housing portion 231) toward the cooling and heating unit 410.

The sealing portions 233e and 233 g are hard because of being bonded, and the protruding portions 233h and 233i are hard because of being folded. In one embodiment, as illustrated in FIG. 6, a length of the cooling and heating structure 400 in the length direction (x direction) is set to be less than a length between the sealing portions 233e and 233 g and, depending on the bonding, between the protruding portions 233h and 233i. As a result, the cooling and heating structure 400 fits between the sealing portions 233e and 233 g and, depending on the bonding, between the protruding portions 233h and 233i, and adhesion between the exterior body 230 and the highly viscous fluid 440 is improved. Furthermore, since the cooling and heating structure 400 fits between the sealing portions 233e and 233 g and, depending on the bonding, between the protruding portions 233h and 233i, a distance between the laminate 210 and the cooling and heating structure 400 is shortened, thermal resistance is reduced, and in addition, the cooling and heating structure 400, for example, the heat transfer member 420 can be thinned, which contributes to improvement of heat transfer properties, and cost reduction. In addition, as a result, the laminate 210 can be made larger in the Y direction (or the volume can be increased) in the battery module BM of the same size, which can also contribute to improvement of an energy density of the battery module BM.

On the other hand, when the length of the cooling and heating structure 400 in the length direction is longer than the length between the sealing portions 233e and 233 g or the length between the protruding portions 233h and 233i, a portion where the highly viscous fluid 440 cannot come into contact is formed in the exterior body 230 of the secondary battery 200, that is, a gap is formed between the exterior body 230 and the highly viscous fluid 440, and air having low heat transfer properties may remain in the gap. Alternatively, a distance between the exterior body 230 and the cooling and heating structure 400 becomes long (for example, several millimeters or more), and the thermal resistance may become large even if the distance can be filled with the highly viscous fluid without a gap.

### Cooling and Heating Unit

The cooling and heating unit 410 cools or heats the secondary battery 200. In the present embodiment, the cooling and heating unit 410 is a heat sink through which a refrigerant or a heat medium passes through a fluid passage 412 formed in a plate-shaped member 411. However, the cooling and heating unit 410 may have, for example, an air-cooling type cooling structure that introduces traveling wind during traveling of a vehicle, or other known techniques can be appropriately used.

### Heat Transfer Member

The heat transfer member 420 moves the heat of the secondary battery 200 or the heat to the secondary battery 200 to the cooling and heating unit 410 or from the cooling and heating unit 410. The heat transfer member 420 is disposed between the secondary battery 200 and the cooling and heating unit 410. As the heat transfer member 420, a thermally conductive gel such as a silicone gel may be used. Furthermore, for example, as the heat transfer member 420, an adhesive material that is cured after application, a silicone putty sheet for heat dissipation that is clayey and closely adheres to irregularities, silicone grease for heat dissipation, or the like can be adopted. The heat transfer member 420 can fix the intermediate member 430 disposed between the sealing portions 233e and 233 g or between the protruding portions 233h and 233i. Furthermore, the heat transfer member 420 can suppress or prevent a gap between the cooling and heating unit 410 and the intermediate member 430.

### Intermediate Member

The intermediate member 430 moves the heat of the secondary battery 200 or the heat to the secondary battery 200 to the cooling and heating unit 410 or from the cooling and heating unit 410 via the heat transfer member 420. The intermediate member 430 is disposed between the secondary battery 200 and the heat transfer member 420, and is in contact with the heat transfer member 420. The intermediate member 430 is not particularly limited as long as it is a member having thermal conductivity and can hold the highly viscous fluid 440 described later, and a metal film, a composite film containing metal, or the like is used. Examples of the intermediate member 430 include a laminate film, a metal foil such as aluminum, and a metal sheet used in the exterior body 230. Alternatively, even if the intermediate member 430 is formed of a member having low thermal conductivity, if the member is a thin film (resin) of, for example, 0.5 mm or less, the intermediate member can be used as the intermediate member 430 since the thermal resistance is low.

When a thermally conductive gel is used as the heat transfer member 420, the intermediate member 430 suppresses that the heat transfer member 420 is mixed with the highly viscous fluid 440, and durability of the cooling and heating structure 400 is improved. In addition, when a member having rigidity is adopted as the intermediate member 430, placement of the secondary battery 200 is facilitated.

### Highly Viscous Fluid

The highly viscous fluid 440 moves the heat of the secondary battery 200 or the heat to the secondary battery 200 to the cooling and heating unit 410 or from the cooling and heating unit 410 via the intermediate member 430 and the heat transfer member 420. The highly viscous fluid 440 is disposed between the secondary battery 200 and the intermediate member 430, and is in contact with the secondary battery 200 and the intermediate member 430. As the highly viscous fluid 440, grease having thermal conductivity can be used, and examples of the grease include mineral oil and silicone blended with a thermally conductive filler. As the highly viscous fluid, for example, one having ASTM (JIS) consistency of 1 to 6 can be used from the viewpoint of reducing pump out. Alternatively, even if the highly viscous fluid 440 is formed of a member having low thermal conductivity, if the member is a thin film of, for example, 0.5 mm or less, the highly viscous fluid can be used as the highly viscous fluid 440 since the thermal resistance is low. On the other hand, when the grease having thermal conductivity is used as the highly viscous fluid 440, the thickness thereof may be, for example, more than 0.5 mm.

In the charging and discharging of the secondary battery 200, the side surface 231a (including the bent portion a) of the housing portion 231 may expand and contract; however, at that time, the secondary battery 200 can slide on the highly viscous fluid 440, and adhesion between the secondary battery 200 and the intermediate member 430 is maintained. When the expansion and contraction of the secondary battery 200 are large, the adhesion between the exterior body 230 and the highly viscous fluid 440 is improved by adopting high viscosity grease as the highly viscous fluid 440.

On the other hand, when the expansion and contraction are followed by the heat transfer member 420 without providing the highly viscous fluid 440, it is necessary to secure the thickness of the heat transfer member 420 in the width direction of the secondary battery 200 so that the heat transfer member 420 expands and contracts so as to follow the expansion and contraction of the side surface 231 a of the housing portion 231. However, in the present embodiment, since the secondary battery 200 can slide on the highly viscous fluid 440, it is not necessary to secure the thickness of the heat transfer member 420, a use amount of the heat transfer member 420 can be reduced, and the thermal resistance is also reduced since the thickness is thin. As a result, the laminate 210 can be made larger in the Y direction (or the volume can be increased) in the battery module BM of the same size, which can also contribute to improvement of the energy density of the battery module BM.

As described above, the side surface 231a of the housing portion 231 including the bent portion a has a flat portion. By bringing the highly viscous fluid 440 into contact with the side surface 231a as the flat portion, cooling and heating efficiency of the secondary battery 200 is improved. Even if the side surface 231a of the housing portion 231 has slight irregularities, the highly viscous fluid 440 can be deformed according to the shape thereof; therefore, a gap between the secondary battery 200 and the intermediate member 430 is filled, and a decrease in cooling and heating efficiency of the secondary battery 200 is suppressed.

Referring again to FIG. 5, the recess 236 is a depression with a depth d1 with respect to the portion 234, and the recess 237 is a depression with a depth d2 with respect to the portion 235. Here, although the depth d1 = the depth d2, the depths of the recesses 236 and 237 may be different. The recess 236 and the recess 237 are separated from each other by a width of the bent portion a.

Accordingly, a width of the side surface 231a of the housing portion 231 is a sum of the depths d1 and d2 of the recesses 236 and 237 and the width of the bent portion a. As illustrated in FIG. 7, the length of each of the heat transfer member 420, the intermediate member 430, and the highly viscous fluid 440 in the thickness direction (Z direction) of the secondary battery 200 is equal to or longer than the length of the side surface 231a of the housing portion 231. Accordingly, the cooling and heating efficiency of the secondary battery 200 is improved.

### <Summary of Embodiment>

The above embodiment discloses at least the following battery module.

1. A battery module (100) according to the above embodiment comprises:
a plurality of secondary batteries (200);
a cooling and heating unit (410) configured to cool or heat the secondary batteries (200); and
a heat transfer member (420) disposed between the secondary batteries (200) and the cooling and heating unit (410),
wherein a highly viscous fluid (440) in contact with the secondary batteries (200) and an intermediate member (430) in contact with and holding the highly viscous fluid (440) are arranged between the secondary batteries (200) and the heat transfer member (420).

According to this embodiment, since the secondary battery can slide on the highly viscous fluid when the secondary battery expands and contracts, the adhesion of the highly viscous fluid to the secondary battery is maintained, and the heat of the secondary battery or the heat to the secondary battery can be efficiently moved to or from the cooling and heating unit.

2. In the above embodiment,
the secondary batteries (200) include a laminate (210) in which a positive electrode layer (211, 212), an electrolyte layer (219), and a negative electrode layer (213, 214) are stacked, and an exterior body (230) wrapping the laminate (210),
the exterior body (230) includes a housing portion (231) that houses the laminate (210), and
the highly viscous fluid (440) is in contact with the housing portion (231).

According to this embodiment, since the housing portion wrapping the laminate of the secondary battery is in contact with the highly viscous fluid, the heat of the secondary battery or the heat to the secondary battery can be efficiently moved to or from the cooling and heating unit.

3. In the above embodiment,
the exterior body (230) is formed by bending a material forming the exterior body (230) at a bent portion (a), the housing portion (231) including the bent portion (a) as a part thereof, and
the exterior body (230) includes a peripheral edge portion (233) around the housing portion (231), the peripheral edge portion (233) including a sealing portion (233e, 233f, 233 g) to which the material is bonded.

According to this embodiment, the housing portion for housing the laminate is easily formed.

4. In the above embodiment, a site of the housing portion (231) including the bent portion (a) has a flat portion, and the flat portion is in contact with the highly viscous fluid (440).

According to this embodiment, the cooling and heating efficiency of the secondary battery is improved by contact of the flat portion.

5. In the above embodiment,

the bent portion (a) of the housing portion (231) is located between the sealing portions (233e, 233 g), the sealing portion (233e, 233 g) protrudes from the bent portion (a) of the housing portion (231) toward the cooling and heating unit (410), and the highly viscous fluid (440) and the intermediate member (430) are arranged between the sealing portions (233e, 233 g).

According to this embodiment, a gap between the exterior body and the highly viscous fluid is reduced or eliminated, it is possible to prevent air from remaining with low heat transfer properties, and the cooling and heating efficiency of the secondary battery is improved. In addition, since the laminate can be made larger in the Y direction (or the volume can be increased) in the battery module BM of the same size, the energy density of the battery module BM can be improved.

6. In the above embodiment,

the secondary batteries (200) include a terminal (221, 222) connected to the laminate (210), and the terminals (221, 222) are arranged at both ends in a longitudinal direction of the secondary batteries (200).

According to this embodiment, heat generated by the current in the longitudinal direction of the secondary battery during charging can be efficiently cooled by the cooling and heating structure.

7. The battery module (100) according to the above embodiment,

the secondary batteries (200) are alternately stacked with a separator (300) having an insulating property.

According to this embodiment, the heat of the secondary battery or the heat to the secondary battery can be efficiently moved to or from the cooling and heating unit.

The invention is not limited to the foregoing embodiments, and various variations/changes are possible within the spirit of the invention.

What is claimed is:

1. A battery module comprising:
a plurality of secondary batteries;
a cooling and heating unit configured to cool or heat the secondary batteries; and
a heat transfer member disposed between the secondary batteries and the cooling and heating unit,
wherein a highly viscous fluid in contact with the secondary batteries and an intermediate member in contact with and holding the highly viscous fluid are arranged between the secondary batteries and the heat transfer member.

2. The battery module according to claim 1,
wherein the secondary batteries include a laminate in which a positive electrode layer, an electrolyte layer, and a negative electrode layer are stacked, and an exterior body wrapping the laminate,
the exterior body includes a housing portion that houses the laminate, and
the highly viscous fluid is in contact with the housing portion.

3. The battery module according to claim 2,
wherein the exterior body is formed by bending a material forming the exterior body at a bent portion, the housing portion including the bent portion as a part thereof, and
the exterior body includes a peripheral edge portion around the housing portion, the peripheral edge portion including a sealing portion to which the material is bonded.

4. The battery module according to claim 3, wherein a site of the housing portion including the bent portion has a flat portion, and the flat portion is in contact with the highly viscous fluid.

5. The battery module according to claim 3, wherein the bent portion of the housing portion is located between the sealing portions, the sealing portion protrudes from the bent portion of the housing portion toward the cooling and heating unit, and the highly viscous fluid and the intermediate member are arranged between the sealing portions.

6. The battery module according to claim 2, wherein the secondary batteries include a terminal connected to the laminate, and the terminals are arranged at both ends in a longitudinal direction of the secondary batteries.

7. The battery module according to claim 1, wherein the secondary batteries are alternately stacked with a separator having an insulating property.
